(19) United States
(12) Patent Application Publication
(10) Pub. No.: US 2002/0090957 A1
(43) Pub. Date: Jul. 11, 2002

(54) Provision of position information in cellular network data transmission

(75) Inventor: Robert Harris, Christchurch (GB)

Correspondence Address: Jeanine S. Ray-Yarletts, IBM Corp, IP Law Dept T81/503,, 3039 Cornwallis Road,, PO Box 12195,, Research Triangle Park, NC, 27709-2195, US

(73) Assignee: International Business Machines Corporation, Armonk, NY

(21) Appl. No.: 10/045,966

(22) Filed: Jan. 10, 2002

(30) Foreign Application Priority Data
Jan. 10, 2001 (GB) 0100668.3

(51) Int. Cl. H04Q 7/20

(52) U.S. Cl. 455/456; 455/457; 342/450; 342/451

(57) ABSTRACT

A cellular telecommunications system comprises a plurality of transceiver stations forming a network for transmission of signals between a mobile communications device and an internet based server hosting an application which is dependent on the position of the mobile device. The position of the mobile device is provided to the application as part of the initial request for the service from the device, thus avoiding the need for multiple flows of information. The position may be based simply on the known location of the transceiver station with which the device establishes wireless connection, with directional or signal strength range information added, if available. Alternatively, the position may be estimated more accurately from the signal received at multiple transceiver stations. In either case an accuracy estimate can be added to the determined position.

### FIELD OF THE INVENTION

The present invention relates to the provision of position information in data transmissions within a cellular network

### BACKGROUND OF THE INVENTION

Increasing numbers of applications using mobile communication devices such as mobile phones or WAP (Wireless Application Protocol) enabled computing devices make use of information about the position of the mobile communication device. For example, emergency services may require the location of a caller to be provided. Commercial applications, too, make use of caller location in order to determine what services or information to offer. These can simply include information about the nearest shop, restaurant or filling station to the caller or may be more complex billing systems for differentially charging the user for a service depending on his whereabouts.

The most basic information on mobile device position is the location of the cell or sector radio mast (transceiver) which is handling the call, which is usually the nearest to the device. This may be further refined by signal strength information or direction information, if directional antennae are employed. Various alternatives offering more accuracy, like triangulation based on directional signals from several masts or on distance estimates derived from signal strengths or transmission times to several masts have been proposed. Even more accurate position information may be available from the mobile device itself if it is enabled for GPS (Global Positioning System) but this requires additional hardware and software to allow the device to contact the necessary geostationary satellites.

More detail of the status of wireless location-based services may be found in several articles on the Internet:

“Wireless Location System” (Sadhana Kant) at http://www.glue.umd.edu/˜skant/project621.html

“Location-Based Services offer a Global Opportunity for New Revenue” (Eric McCabe, Telecommunications Online, October 1999) at

http://www.telecoms-mag.com/issues/199910/tcs/location.ht ml

“Location-Based Technology pushes the Edge” (R. Boswell, Telecommunications Online, dated June 2000) at

http://www.telecoms-mag.com/issues/200006/tcs/location. html.

However, the systems described in the above referenced prior art all presuppose a request for position information, either from the server hosting the application or from the mobile device itself. This involves at least two and up to four communication flows before the requesting application can receive and make use of the position information. It may also require a private client/server protocol between the device and the server application.

In U.S. Pat. No. 5,873,040, “Wireless 911 Emergency Location, a system is described for locating the position of an emergency caller by computing a likely location area from the strength of signal received by several neighbouring masts. The location area information is applied to a further database which contains explicit geographic or topographic information based on area and this more detailed information is passed on to the emergency service to assist with final location of the caller.

Mobile communication devices employ various technologies and conform to various protocols for the transmission and receipt of signals. A common transmission protocol is the GSM (Global Systems for Mobile Communications) standard in use in Europe. To allow mobile devices to access the Internet, which uses HTTP (Hypertext Transfer Protocol) to transmit web pages coded in HTML (Hypertext Markup Language), the WAP protocol has been developed. This conforms to basic HTTP and allows WAP enabled devices to receive the core information content of HTML pages in a simplified representation, excluding pictures, known as WML (Wireless Markup Language). WAP coded signals may be received and handled directly by Internet Service Providers whose systems recognise WAP, or may be converted by a gateway computer to HTTP/HTML form. Internet connection allows mobile device users to access ISP websites and use ISP applications to make retail purchases or obtain information. Some of these applications, as pointed out above may require positional information about the communicating mobile device. Such applications request positional information from the mobile device or a network location service after they have been started.

Two papers discussing such position information requirements from a conference held in March 2000 are available on the Internet:

“WAP Based Location Services” , S. Souissi and G. Phillips, Motorola, at

http://www.w3.org/Mobile/posdep/MotorolaW3C.html

“Workshop on Position Dependent Information Services”, P. King, Phone.Com, at

http://www.w3.org/Mobile/posdep/PDCPositionLoc.html

### SUMMARY OF THE INVENTION

Rather than wait for a service requiring positional information of known accuracy to request it, according to one aspect the present invention provides a cellular telecommunications system, a computer program product and a method of communicating a request for a service from a mobile telecommunications device to said service via a cellular wireless network including a plurality of transceiver stations, each located in a corresponding cell, comprising the steps of: establishing a wireless connection between said mobile device and one of said transceivers; transmitting a request for the service from the mobile device to the transceiver; determining the position of said mobile device; estimating the accuracy of said position determination; transmitting said request through the network and onward to the service, said transmitted request including position and accuracy information about the mobile device.

Such automatic insertion of position information into every transmission obviates the need for specific requests and interchanges for such information. Including an accuracy figure assists the receiving service in being able to determine which services it can provide. For example, mobile cell identification may be enough for weather information but more detail would be required for retail or emergency help information. Whether or not automatic position information is provided in this way may, of course, be a user option so that it could be switched on or off as appropriate.

The simplest way of providing position information is just to add the known position of the nearest radio mast (which will normally be the one allocated by the cellular network to be the primary mast for the call) to the transmitted data signal. This would be rather inaccurate but may be adequate for some applications.

Preferably, this would be supplemented by information giving the direction of the mobile device. Such information could be obtained from directional antennae and can be further supplemented by signal strength measurements, giving distance from the antenna. If, however, signals from multiple antennae are used, more accurate position information can be obtained via any of the known methods discussed above, such as triangulation, signal strength or timing of signals received at the multiple antennae.

If the mobile device is actually enabled for GPS, it can directly provide its known satellite referenced position in every transmission. The point is not what position sensing technology is used but that position information can be inserted directly and automatically into every transmission from the device.

According to a second aspect, the invention also provides a cellular telecommunications system, a computer program product and a method of communicating a request for a service from a mobile telecommunications device to said service via a cellular wireless network including a plurality of transceiver stations, each located in a corresponding cell, comprising the steps of: establishing a wireless connection between said mobile device and one of said transceivers; transmitting a request for the service from the mobile device to the transceiver; estimating the position of said mobile device from the position of said one transceiver from a table of stored transceiver positions; and transmitting said request through the network and onward to the service, said transmitted request including said estimated position information about said mobile device.

This aspect of the invention has the advantage that position information is provided in a single outbound flow from the mobile device from signals available at a single transceiver.

### BRIEF DESCRIPTION OF THE DRAWINGS

FIG. 1 shows a wireless communications network in which position information is included in data transmissions according to the present invention

FIG. 2 is a flow diagram illustrating a method of providing position information in a cellular network data transmission according to the present invention;

FIG. 3 illustrates one way of determining mobile device position used in the method of FIG. 2;

FIG. 4 illustrates the principle of position accuracy estimation employed in the method of FIG. 2; and

FIG. 5 illustrates an alternative way of determining position in the method of FIG. 2.

### DETAILED DESCRIPTION OF THE PREFERRED EMBODIMENT

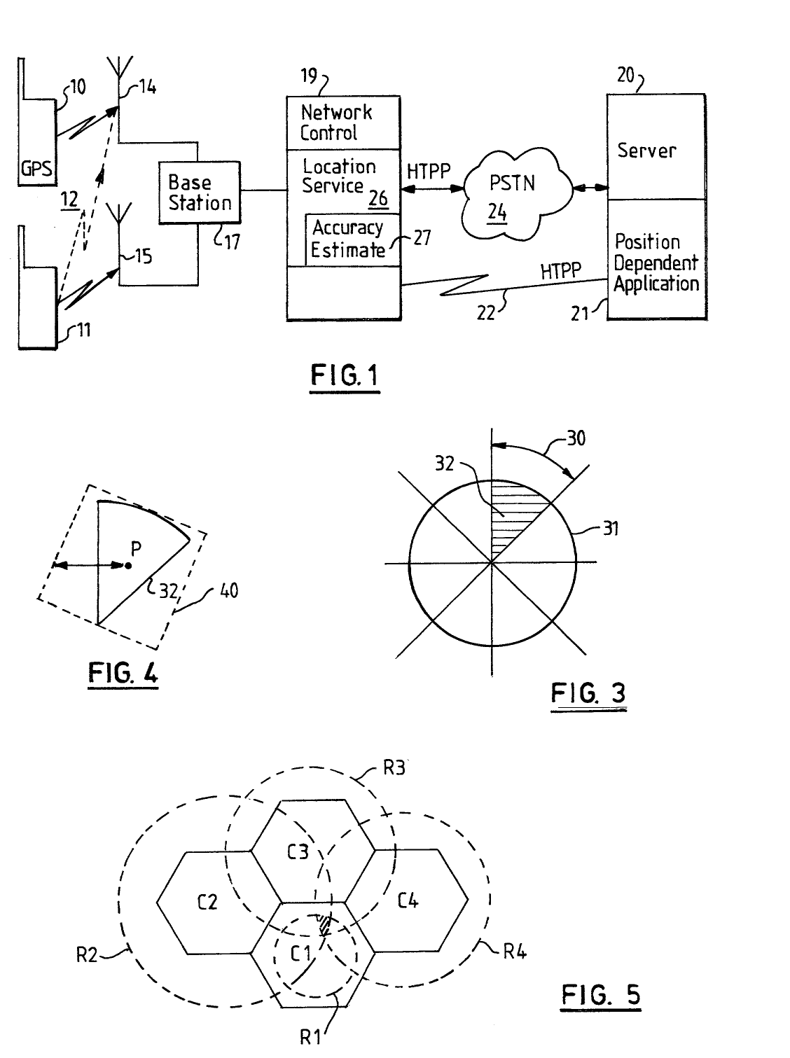

As shown in FIG. 1, a wireless communication network is illustrated in which mobile phones, such as 10 and 11, communicate through a cellular system 12 of radio masts (antennae), such as 14 and 15, base station 17 and network controller 19, with a remote server 20 hosting a position dependent application 21. Communication between the network controller 19 and the server 20 may be wireless, across a link 22 or through the public switched network 24 by landline. The wireless connection of the server may be through the same cellular system 12, though no masts have been shown for added clarity. Within network controller 19 are a location service 26, including an accuracy estimator 27.

The mobile phones 10 and 11 are assumed to be internet enabled devices capable of transmitting and receiving packets of information interactively, using the WAP or HTTP protocols, between themselves and the application 21 on server 20. The application 21 may be any position dependent application providing an information or transaction service. Typical information services may be weather or road condition services or the location of retail, banking or accommodation services. A suitable transaction service could be a chargeable service with differential rates dependent on position such as a telephone charging service or a vehicle access pricing service. The actual application is not important to the invention.

In the prior art, these services would first be accessed by the mobile device and would subsequently interrogate either the device or the network as to the position of the user. After the position information is provided, the applications then provide their services in dependence on the result. Some services expect the user to provide its own position before allowing the service to commence so that the user device has to interrogate the network to determine its position before accessing the service proper. This can lead to an excess of information flows back and forth between the mobile device and server which is wasteful.

The invention avoids this by providing as far as possible the position of the calling mobile device in the first outbound transmission to the server when initially requesting the service. To assist the server application in determining what service it can provide, not only the position but also an accuracy figure for that position is provided. The application can limit its response to what is available for a given accuracy of position or it can respond by further interrogation of the mobile device or user.

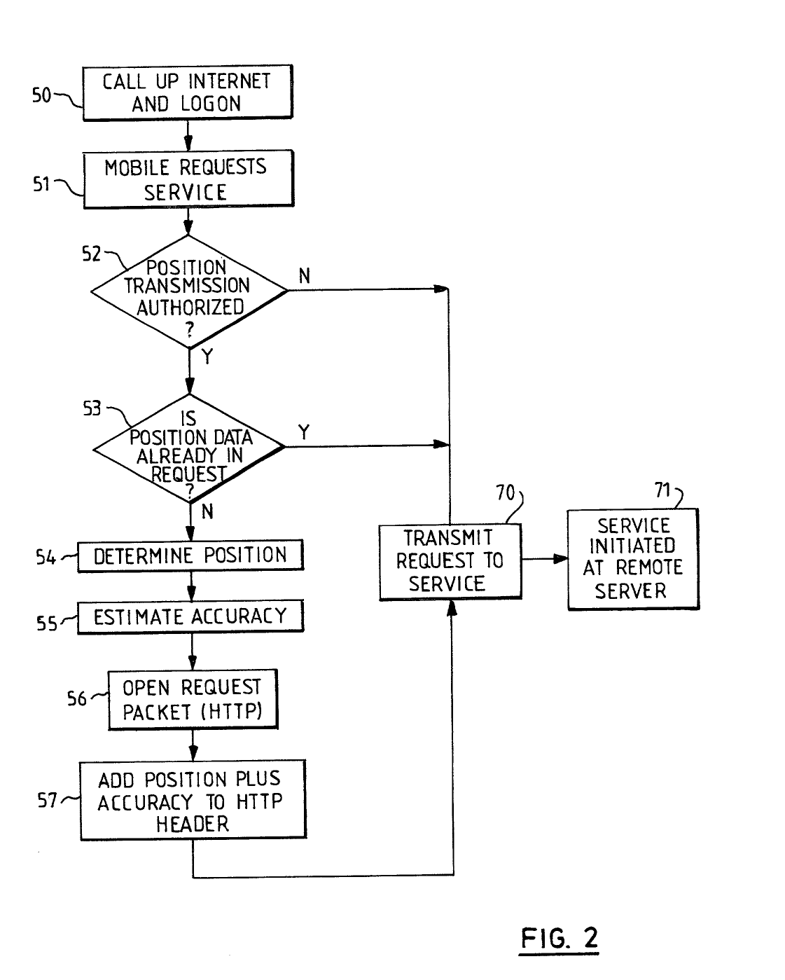

The operation of the system of FIG. 1 will now be described in connection with the flow diagram of FIG. 2 and the illustrations of FIGS. 3, 4 and 5.

In FIG. 2, the first step 50 is for one of the mobile devices 10 or 11, which are assumed to be internet enabled, to call up and logon to an Internet Service Provider. At step 51, the mobile user requests a particular service by selection from choices offered by the Internet Service Provider. It is assumed that the mobile device user may choose whether or not to permit its position to be determined and transmitted automatically and that this information is stored in the mobile device. This may be under user control, for reasons of privacy, or may be selectively determined in dependence on the nature of the service request, so that unnecessary position information is not added. In step 52, if position transmission is not authorised, the request is simply transmitted, in step 70, to initiate the service in step 71. If the initiated service requires position information, it must then request it from the user in conventional fashion.

If, however, the mobile device is set up to enable automatic transmission of its position, then in step 53, location service 26 determines whether position data is already in the request. In the case of device 10, which is GPS enabled, the data is already present and can be transmitted directly to the service in step 70.

If position data is not present, as in the case of the device 11, then the location service determines it in step 54 with an appropriate accuracy estimation in step 55. In this embodiment of the invention, the location service simply takes the position it can deduce from receipt of the signal from the device 11 at mast 15. Mast 15 is assumed to be the nearest or one of the nearest masts to device 11, which has been allocated control of the call from device 11 by the cellular network. The basic component of position information is the geographic location of the mast which may be stored in a database. However, further information about the distance of the device from the mast may be obtained from the signal strength and, if the mast has one or more directional antennae, information on a directional range for the device can be obtained. In this case, as schematically illustrated in FIG. 3, the position of the device 11 can be determined to be in a sector 30 and within a range delimited by circle 31, as shown by the shaded area 32.

To determine the accuracy of this position estimate, accuracy estimator 27 (ref FIG. 4) computes a notional square 40 around area 32 which just contains the extremities of the area. Alternatively, any other regular polygon or a circle may be fitted to area 32.

The estimated or most likely position of device 11 is taken to be the centre of the square, at position P, and the accuracy is estimated to be the half dimension of the square. Clearly, other ways of estimating the position and accuracy from a shaped area are possible, such as determining the centre of gravity of the shape and the mean distance from the centre of gravity to the boundaries.

This determination of position can be adequate for the provision of many services and, returning to FIG. 2, the next step is for the location service 26 to open the request packets, in step 56. The location service then adds the position and accuracy information to the HTTP flow from the device 11, in step 57. This is then transmitted in step 70 to initiate the requested service in step 71. The position and accuracy information may be added as a new header portion or may be inserted in a pre formatted header space, initially filled with null values.

The format of the position information is

Mobile_Position: Latitude, Longitude (Latitude Accuracy, Longitude Accuracy)

An example of this would be:

73:23:34N,001:25:54E(000:01:30,000:02:00)

This would mean that the device's estimated position was 73 degrees, 23 minutes and 34 seconds North, 1 degree, 25 minutes and 54 seconds East. The accuracy on longitude is 1 minute 30 seconds of arc and on latitude is 2 minutes of arc.

In a variant on the above embodiment, if a more accurate position is likely to be required than can be obtained from information on the signal at a single mast, a more complex position calculation can be made by the location service 26, based on the signals received at several masts. One suitable technique is that described in the referenced U.S. Pat. No. 5,873,040 which is illustrated in FIG. 5. Signals from device 11 are assumed to be received by masts, such as masts 14 and 15 in FIG. 1, in each of a cluster of cells, C1, C2, C3, C4. Based on signal strength at each of the masts, a series of likely range circles R1, R2, R3 and R4 may be drawn. The position of the device is most likely to be in the shaded area formed by the intersection of the four circles. This is a much smaller area than can be deduced from signals at a single mast alone and the corresponding accuracy of position is much greater.

If encryption of user data is employed, such as by using the SSL (Secure Sockets Layer) protocol, then it is optional whether the added position and accuracy information should also be encrypted. Preferably, the position and accuracy data should flow in clear but, if it is encrypted, this must be with the same key which the serving application uses.

1. A method of communicating a request for a service from a mobile telecommunications device to said service via a cellular wireless network including a plurality of transceiver stations, each located in a corresponding cell, comprising the steps of:
establishing a wireless connection between said mobile device and one of said transceivers;
transmitting a request for the service from the mobile device to the transceiver;
determining the position of said mobile device;
estimating the accuracy of said position determination;
transmitting said request through the network and onward to the service, said transmitted request including position and accuracy information about the mobile device.

2. A method as claimed in claim 1 in which said position determining step includes the step of obtaining the position of said one transceiver from a table of stored transceiver positions and in which said estimating step estimates the accuracy of said position determination from known cell dimensions.

3. A method as claimed in claim 2 in which said position determining step includes a further determination based on signal strength at said one transceiver.

4. A method as claimed in claim 1 in which said position of said mobile device is partly determined by detecting signal direction at said one transceiver.

5. A method as claimed in claim 1 in which the position of said mobile device is determined by analysing signals received at several of the transceivers.

6. A method as claimed in claim 1 in which said position of said mobile device is determined by said mobile device itself from satellite position reference signals.

7. A method as claimed in claim 1 in which said position determination is responsive to a request for service.

8. A method as claimed in claim 1 in which said position determining step takes place in said network when said device connection is established, said method including the further step of downloading and storing said position and accuracy information in said mobile device for subsequent transmission in the course of a request for service.

9. A method as claimed in claim 8 in which said position determining step takes place at intervals subsequently to said device connection being established.

10. A method as claimed in claim 1 in which the device position is determined to lie within a shaped area and accuracy is estimated from the boundaries of a circle or regular polygon fitted to said shaped area.

11. A method as claimed in claim 1 in which said service is an internet based service, said request being transmitted according to a predetermined protocol, said position and accuracy information being placed in a header field of said protocol.

12. A method as claimed in claim 11 wherein the protocol is Hypertext Transfer Protocol (HTTP).

13. A method as claimed in claim 11 in which said protocol includes user data, including the steps of encrypting said user data but not said position and accuracy information.

14. A method as claimed in claim 1 including the step of selectively controlling said position determination and transmission steps.

15. A method as claimed in claim 14 in which said selective control step is dependent on the nature of said request.

16. A method of communicating a request for a service from a mobile telecommunications device to said service via a cellular wireless network including a plurality of transceiver stations, each located in a corresponding cell, comprising the steps of:
establishing a wireless connection between said mobile device and one of said transceivers;
transmitting a request for the service from the mobile device to the transceiver;
estimating the position of said mobile device from the position of said one transceiver in a table of stored transceiver positions; and
transmitting said request through the network and onward to the service, said transmitted request including said estimated position information about said mobile device.

17. A method as claimed in claim 16 in which said position determining step includes a further estimation based on signal strength at said one transceiver.

18. A method as claimed in claim 16 in which said position is partly estimated by detecting signal direction at said one transceiver.

19. A method as claimed in claim 18 which includes the further step of testing whether position information is already included in said request and making said estimating step conditional on whether positional information is already included or not.

20. A method as claimed in claim 16 including the further steps of estimating the accuracy of said estimated position information and transmitting said accuracy estimate along with said request.

21. A computer program product recorded on a medium, said program comprising instructions which, when executed on a computer in a cellular telecommunications system, automatically provides information on the position of a mobile telecommunications device according to a method as claimed in claim 1.

22. A computer program product recorded on a medium, said program comprising instructions which, when executed on a computer in a cellular telecommunications system automatically provides information on the position of a mobile telecommunications device according to a method as claimed in claim 16.

23. A cellular telecommunications system comprising a plurality of transceiver stations forming a network for the transmission of signals from or to any of a plurality of mobile communication devices to an internet based server;
a location service means, responsive to a request from a mobile communications device for a service located on such a server, to determine the position of said mobile device;
means for estimating the accuracy of said position determination;
means for adding said position and accuracy information to said request for transmission to said server

24. A system as claimed in claim 23 in which said location service means is arranged to obtain the position of said one transceiver from a table of stored transceiver positions and in which said means for estimating estimates the accuracy of said position determination from known cell dimensions.

25. A system as claimed in claim 24 in which said location service means is further adapted to determine position based on signal strength at said one transceiver.

26. A system as claimed in claim 25 in which said location service means is also adapted to detect signal direction at said one transceiver.

27. A system as claimed in claim 23 in which said location service means determines the position of said mobile device by analysing signals received at several of the transceivers.

28. A system as claimed in claim 23, in which said mobile device includes means for determining its position from satellite position reference signals.

29. A system as claimed in claim 23 in which said location service means is responsive to a request for service.

30. A system as claimed in claim 23 in which said location service means determines the position of a mobile communication device upon connection of said device to said network, said system further including means for downloading and storing said position and accuracy information in said mobile communication device for subsequent transmission in the course of a request for service.

31. A system as claimed in claim 23 in which said location service means determines that the device position lies within a shaped area and said means to estimating accuracy is estimated from the boundaries of a circle or regular polygon fitted to said shaped area.

32. A cellular telecommunications system comprising a plurality of transceiver stations forming a network for transmission of signals from or to any of a plurality of mobile communication devices to an internet based server;
location service means, responsive to a request from a mobile communications device for a service located on such a server, to estimate the position of a mobile device, said position estimate being based on the position of the one of said transceiver stations receiving the strongest signal from said device, from a table of stored transceiver positions; and
means for adding said position estimate to said request for transmission to said server.

33. A system as claimed in claim 32 in which said position estimate is based on signal strength at said one transceiver.

34. A system as claimed in claim 32 in which said position estimate is partly based on signal direction at said one transceiver.

35. A system as claimed in claim 34 further including means for testing whether position information is already included in said request and making said position estimation conditional on whether positional information is already included or not.

36. A system as claimed in claim 32 further including means for estimating the accuracy of said estimated position information and transmitting said accuracy estimate along with said request.
